(19) United States
(12) Patent Application Publication
(10) Pub. No.: US 2025/0153414 A1
(43) Pub. Date: May 15, 2025

(54) TWO-DIRECTION MATERIAL HEATING SYSTEM

(71) Applicant: GREENOVEL INC., Saint-Constant (CA)

(72) Inventors: Sherif FARAG, Saint-Constant (CA); Mai ATTIA, Saint-Constant (CA)

(21) Appl. No.: 18/715,224

(22) PCT Filed: Dec. 22, 2022
(86) PCT No.: PCT/CA2022/051890

§ 371 Date: May 31, 2024

Related U.S. Application Data
(60) Provisional application No. 63/354,687, filed on Jun. 23, 2022.
(60) Provisional application No. 63/295,834, filed on Dec. 31, 2021.

(51) Int. Cl. B29C 48/84; B29C 35/08; B29C 48/395; B29C 48/80; H05B 6/64

(52) U.S. Cl. CPC B29C 48/845; B29C 35/0805; B29C 48/397; B29C 48/832; H05B 6/6491; B29C 2035/0855; B29K 2909/04

(57) ABSTRACT

There is provided a two-direction heating system which comprises one or more heat-absorber modules. Each heat-absorber module comprises a heat-absorber barrel, a heat-absorber screw attached to an internal region of the barrel, and one or more heating units each attached to an external region of the barrel. Heat generated by the heating unit and delivered to first heat-absorber receptors provided on an inner surface of the barrel and second heat-absorber receptors provided on an outer surface of the screw, circulates from the barrel to the screw and from the screw to the barrel, and is thereby transferred to a material placed in the interior region of the heat-absorber barrel.

### CROSS REFERENCE TO RELATED APPLICATIONS

This application claims benefit of U.S. Provisional Patent Application No. 63/295,834 filed on Dec. 31, 2021. Also, this application claims benefit of U.S. Provisional Patent Application No. 63,354/687 filed on Jun. 23, 2022. The content of each of these two applications is incorporated herein in its entirety by reference.

### FIELD OF THE INVENTION

The present invention relates generally to systems for heating materials. More specifically, the invention relates to a two-direction heating system. The invention also relates to material treatment processes and material treatment plants that embody such heating system. Moreover, the invention relates to extrusion devices that embody such heating systems.

### BACKGROUND OF THE INVENTION

Around 368 million metric tons of plastic were produced worldwide in 2019. Considering the growing global population and economy, the demand for plastic increases further. In Canada, around 3.84 million tons of plastic waste are generated annually, of which only 14% is recycled while the rest is discarded into the environment, leading to severe environmental and economic problems.

Plastic recycling methods known in the art include the following:
(a) Plastics-to-fuel: It emits hazardous gases, recovers only about 20% of the energy required to create plastic from hydrocarbons, and requires product upgrading before being used directly as an energy source.
(b) Plastics-to-monomers, such as pyrolysis: It produces a complex mixture of monomers—not a single building block monomer of the polymer feedstock—and, thus, downstream separation, extraction, and/or upgrading for the target compound is a must. In most cases, on top of that, “wax” is produced—not monomers—and, consequently, a thermal catalytic downstream process is needed.
(c) Plastics-to-resin conversion, such as extrusion: The quality of the product is worse and cannot compete with virgin plastics due to the uneven temperature distribution created by traditional extruders. It consumes a significant amount of electric energy; as a result, the selling price of the product is comparable to that of the virgin material.

Extrusion systems date back to the 18^{th} century, with the invention of a manual piston extruder for seamless lead tubes being regarded as the world's first extruder in 1795. In the 19^{th} century, extruders were primarily used in the lead tube, food processing, and brick and ceramic industries.

During the 19^{th} century, extrusion processes gained increased attention, and electrically powered extruders swiftly supplanted manually driven extruders. The development of the synthetic polymer industry in the mid-nineteenth century facilitated the application of high molecular material extrusion processing. In 1935, the first single-screw extruder was successfully designed for thermoplastics, establishing the modern extrusion process.

Extrusion is a fundamental technique to process polymeric materials, widely applied for producing a wide range of commercially available products, including packaging, automotive, aerospace, and electrical and electronic equipment. However, plastic extrusion is an energy-intensive process, and which usually operates at a poor energy efficiency.

Usually, the energy demand and loss are primarily determined mainly by the size/age/type of the equipment and the processing parameters like the speed of the screw, the temperature of the barrel, and the properties of the extruded material.

A typical energy flow diagram for conventional extrusion processes depicts that energy consumed in the extrusion process usually results from the drive motor, barrel heater, cooling fans, etc., among which the drive motor is responsible for the most energy consumption in the plastic extrusion.

The drive motor consumes 14% of the energy during the extrusion process. The energy consumption by the derive motor depends on the properties of the processed material(s) at each operating condition and the temperature of each zone along the extruder. Most importantly, the material viscosity and shears on the outer surface of the screw.

After the drive motor, the barrel heater is the second most significant energy consumer in plastic extrusion. Its efficiency is highly dependent on the wattage, material qualities, and screw shape.

The energy required to melt the material to be extruded material is provided chiefly by the barrel heaters and somewhat by the mechanical effort created by the screw spinning. Barrel heaters are resistive loads, and hence no energy efficiency issues are envisaged. To ensure thermal stability, excess process heat is evacuated from the extrusion process using either blower attached to the barrel, barrel wall utilizing water or oil, or internal cooling of the screw core.

Thus, it can be inferred that applying an appropriate amount of heat to the barrel ensures the quality of extrudates by avoiding overheating and reducing the energy loss during the plastic extrusion process. Furthermore, heat can be lost in the water pumps, instrument panels, and other auxiliary devices.

Electric heating has been the most often used way of heating the extrusion process due to its precision, reliability, and ease of installation. Electric heating may be classified into three types: induction, cast-in, and band heaters. Electricity supplies the energy necessary for the extrusion process in the form of a superficial thermal energy transfer.

Apart from electric heating, fluid heating is another kind of heating that may be utilized in plastic extrusion, with oil being the most often used heating fluid. This form of heating presents the following disadvantages: (i) the risk of fire, pollution, and poisoning; (ii) the high cost; (iii) the oil deterioration over time; and (iv) the demand for specific recirculation pumps, carefully constructed valves, and a high degree of insulation.

Additionally, due to the high specific heat and latent heat of vaporization of water, steam heating can be used for plastic extrusion; however, steam heating is rarely used due to the low temperatures that can be achieved, the requirement for high-pressure-resistant piping, the possibility of steam leakage, and corrosion effects.

In general, the existing plastic extruder consumes a significant amount of energy and is frequently operated inefficiently. While increasing the screw speed improves the energy efficiency of plastic extrusion, thermal fluctuations are frequently induced, resulting in extremely poor melt quality.

Considering the increasing rise in the price of global energy, plastic producers are on the lookout for innovative technologies that not only save energy but also maintain the needed melt quality and output rate to maximize their profit margins.

Most extrusion systems known in the art are heated with the use of heating elements dispersed throughout the barrel outside surface; thus, conduction is the primary mode of heat transmission to the payload.

Plastic conducts at a small fraction of the conduction rate of steel, which results in an uneven radial temperature distribution within the payload. Not only does this unbalanced temperature profile results in plastic deterioration or downcycling, it also significantly increases the power of the motor and screw wear.

Most extruders have a long length-to-diameter ratio, which leads to increase in not only the capital expenditures but also the operating expenditures. Furthermore, this limits the applications of extrusion systems in new applications such as the chemical reactions sector.

To overcome most of the issues and limitations associated with the traditional extruders is to replace the one-dimensional superficial heat transfer mode of the conventional heating employed in the market's extruders with a two-dimensional energy conversion mechanism of the unconventional heating techniques.

The unconventional heating techniques include microwave heating, plasma, ultrasound, and induction heating.

Microwave heating is caused by the interaction of electromagnetic radiation with the dipoles of the material being heated. Electromagnetic radiation is made up of photons that travel at the speed of light and carry radiated energy.

Electromagnetic waves are made up of orthogonal alternating electric and magnetic fields that travel in the direction of oscillation. The electromagnetic spectrum encompasses a wide variety of frequencies as well as wavelengths. To avoid overlapping, each electromagnetic application (radio waves, microwaves, infrared, visible light, ultraviolet radiation, X-ray, and gamma-ray) has its own frequency.

Microwaves have a wavelength range of 1 m to 1 mm and a frequency range of 300 MHz to 300 GHz. Microwaves have been created in a range of applications, including communications, navigation, radar detection, power transfer, and microwave heating, due to this rapid rise of electromagnetic wave technology in the twentieth century.

As proven by several industrial sectors, microwave heating is now widely employed in both small-scale applications, such as domestic microwave ovens, and large-scale applications. This is due to an increase in interest in microwave heating research, as indicated by the potential of publication in peer-reviewed journals.

Materials with permanent dipole moments have randomly oriented molecules in the absence of an external alternating electric field. The molecules are aligned with the alternating field by applying an external alternating electric field, resulting in permanent dipoles aligned to the oscillating field.

These aligned dipoles aim to be in phase with the alternating electric field by following the variation of the applied electric field. Because the agitated molecules cannot reorient as quickly as the reversing electric field, however, a phase shift occurs between the orientation and the electric field. As a result of the phase shift, random collisions between the orientated molecules occur, releasing heat energy from the exposed substance. The lag between the orientation and the alternating field does not occur in a perfect dielectric material, and so no heat energy is generated.

To summarize, the major process of microwave-induced heating in non-magnetic materials includes the agitation of molecular dipoles owing to the presence of an oscillating electric field. Microwave is therefore defined as a volumetric energy conversion process that converts electromagnetic energy to heat inside the volume of the heated substance.

This aspect can also take advantage of processing material with a reasonable interaction with microwaves, which, in such a case, selective and local molecular heating can be achieved.

Microwave heating has been created in a variety of applications to use the benefits of electromagnetic radiation as a replacement for traditional heating. Fundamentally, the widespread use of microwave heating is based on direct conversion of electromagnetic energy within the heated material, which is fundamentally different from the surface heat transfer associated with conventional heating.

This distinction allows for the avoidance of a variety of challenges and restrictions connected with conventional heating, the most significant of which is the temperature differential between the target substance and the surrounding environment. Additionally, because electromagnetic waves interact with just certain types of materials, they may heat selectively, which is not feasible with conventional heating.

This aspect is so significant that it can dramatically reduce the amount of heat energy needed to achieve a particular end, which consequently results in decreasing the operating costs as well as the potential of thermal hazards. Moreover, in the case of exposing multiple components, heating can be concentrated at a specific component, which may lead to producing material with a novel microstructure, initiating reactions that cannot be initiated when conventional heating is applied, and/or achieving the existing reactions under conditions that are different from those of traditional processing. However, it should be noted that this mainly depends on the dielectric properties of each component.

Additionally, because microwave heating may be started and stopped easily and fast, the procedure can be finished in a fraction of the time required by the conventional approach. This may increase the velocity of production in a variety of industries while also eliminating undesired intermediary thermal stages. Microwave heating is a heating technique that is accurate and safe, and that enables more control and smaller equipment. Additionally, microwave heating is a green procedure since it decreases dangerous emissions, especially when clean power is employed. Finally, multiple studies have demonstrated that microwave heating may reduce energy use while increasing product quantity and quality when compared to conventionally treatments of materials.

U.S. Pat. No. 3,299,473 discloses an extruding machine that comprises a screw with an internal bore that contains a slidable heater that is reciprocated inside the bore as desired. The heat is transferred through the plurality of slip rings distributed longitudinally so that separate heating means can be separately controlled.

U.S. 2014/158195A1 discloses an extruding machine that can comprise single or double screws within a barrel. A heating unit is attached to the surface of the barrel to control the temperature of the region inside the barrel. The heating unit is distributed in a plurality of regions that can be individually controlled as per the heat requirement in a particular region.

GB 960543A discloses a process and apparatus for extruding a tube or sheet of organic thermoplastic material. In one arrangement, the extrusion orifice is annular, and the heater is formed as a ring mounted in sliding engagement with the outer surface of the die cup for continuous oscillatory or intermittent rotation about the axis of the die. In an alternative arrangement, a slot extrusion die is provided with a heater reciprocating in sliding engagement with the die body on each side of the die orifice at a controlled rate.

CN 201283637Y discloses a screw heat exchange device of a plastic filter. Also, the document discloses the arrangement of heat transfer such that the whole screw has even temperature, thus not affecting gelatinating, material viscosity and smoothly extruding the material.

U.S. Pat. No. 4,405,239A discloses a screw with a mixing section which promotes mixing of the hot, molten material with the cold, unmolten material inside the screw channel by its geometry, thereby improving the heat transfer from the hot, molten material to the cold, unmolten material and increasing the energy efficiency of the extruder.

U.S. Pat. No. 10,596,759 discloses an additive manufacturing system which consists of: an extrusion die; a compacted core material; a channel extending through the compacted core material and comprising an inlet and an outlet, the outlet in fluid communication with the extrusion die; a heating element extending along the channel for melting a filament material received through the inlet such that the filament material can be extruded through the extrusion die; a temperature sensor positioned within the compacted core material, adjacent to the channel between the extrusion die and the heating element wherein the compacted core material holds the temperature sensor in contact against the channel at the outlet; and a sheath enclosing the compacted core material, the channel, the heating element, and the temperature sensor.

U.S. Pat. No. 9,669,576 discloses a method for controlling the temperature of a polymer melt in an extrusion tool, the extrusion tool is configured to attach to an extruder and receive the polymer melt therefrom, the method comprises: flowing a polymer melt via at least one flow channel of the extrusion tool, the flow channel defined by a mandrel and a sleeve surrounding the mandrel, the flow channel extending from at least one melt input in communication with the extruder to at least one melt output and around at least one temperature-control element surrounding the mandrel and disposed in the at least one flow channel, the at least one temperature-control element including a plurality of temperature control units distributed around the temperature-control element; and controlling a temperature of the polymer melt flowing in the flow channel past the at least one temperature-control element by individually controlling each of the plurality of temperature-control units so as to vary a degree of temperature control of the at least one temperature-control element such that the degree of temperature control is controllable to be the same or different at locations around the mandrel.

U.S. 2020/0047387 discloses a design of an energy transfer screw for a single screw extruder, the extruder comprising an extruder barrel with an inside diameter, the screw comprising: an energy transfer section with a distance averaged energy transfer section depth of 8.0% to −10% of the extruder barrel internal diameter; a metering section with a metering section depth of 6.0% to 8% of the extruder barrel internal diameter.

U.S. 2018/0236705 discloses a design of an extruder, which comprises: a barrel extending from a feed inlet end to an extruder outlet end, the barrel having an inner surface, an outer surface and a wall thickness between the inner and outer surfaces; at least one heating member positioned exterior to the barrel; a screw derive motor drivingly connected to a rotatably mounted screw positioned within the barrel, the screw having a length and a flight having a plurality of threads thereon, whereby the screw is rotatable at various revolutions per minute (RPM); and a controller operably connected to the screw drive motor to adjust the RPM of the screw based upon a temperature of material passing through and/or being extruded from the barrel wherein the barrel has a section that has a diameter up to 2.405 inches in which solid feed material is liquefied that is operated at a pressure of 10-400 psi.

CA 2,900,251 discloses a design of an extruder, which comprises: a barrel extending from a feed inlet end to an extruder outlet end, the barrel having an inner surface, an outer surface and a wall thickness between the inner and outer surfaces; at least one heating member positioned exterior to the barrel; a screw drive motor drivingly connected to a rotatably mounted screw positioned within the barrel, the screw having a length and a flight having a plurality of threads thereon, whereby the screw is rotatable at various revolutions per minute (RPM); and a controller operably connected to the screw drive motor to adjust the RPM of the screw based upon a temperature of material passing through and/or being extruded from the barrel wherein the screw and the barrel are sized such that at least 60% of heat that is introduced into the material in the barrel is supplied by the at least one heating member and less than 40% of the heat that is introduced into the material in the barrel is supplied by shearing the material.

CA 2,989,935 discloses a design of an extruder, which comprises: a barrel extending from a feed inlet end to an extruder outlet end, the barrel having an inner surface, an outer surface and a wall thickness between the inner and outer surfaces; at least one heating member positioned exterior to the barrel; a screw drive motor drivingly connected to a rotatably mounted screw positioned within the barrel, the screw having a length and a flight having a plurality of threads thereon, whereby the screw is rotatable at various revolutions per minute (RPM); and a controller operably connected to the screw drive motor to adjust the RPM of the screw based upon a temperature of material passing through and/or being extruded from the barrel wherein the barrel has a wall thickness of from 0.01 to 0.375 inches, a flight clearance between the inner surface of the barrel and an outer extent of the flight is from 0.005 to 0.04 inches, and the screw has a diameter of up to 2 inches.

U.S. Pat. No. 6,652,785 discloses an extrusion system including an extruder for producing an extrudate. The extrusion system comprises a motion detector along the path of movement of an extrudate downstream of the extruder and responsive to movement of the extrudate the repast to produce an output indicative of extrudate movement, an extruder controller coupled to the motion detector to receive the output of the motion detector, and a controlled switching device operatively connecting the extrusion system to an electrical power source, the controller being connected in controlling relation to the switching device, and the controller being responsive to an output of the motion detector indicative of a lack of appropriate movement of the extrudate to cause the switching device to interrupt electrical power to the extrusion system.

There is a need for material heating systems that are efficient and cost effective. In particular, there is a need for such heating systems that allow for an efficient control of the temperature of the material during the heating process. Also, there is a need for material treatment processes and material treatment plants that embody such heating systems. Moreover, there is a need for plastic extrusion devices that embody such heating systems.

### SUMMARY OF THE INVENTION

The inventors have designed and developed a two-direction heating system for heating a material. The system comprises a barrel having at least one screw attached to an interior region thereof, heat generated through heating units attached to the barrel and the screw is circulated from the barrel to the screw and from the screw to the barrel, and the heat is thereby transferred to a material placed in the interior region of the barrel. The two-direction heating system according to the invention allows for an efficient control of the temperature of the region inside the barrel and thus the temperature being transferred to the material.

In embodiments of the invention, the two-direction heating system comprises at least one unconventional heating technique such as microwave heating, plasma, ultrasound, and induction heating. The two-direction heating system according to the invention may also comprise electric heating means and/or fluid heating means. Moreover, the two-direction heating system according to the invention may comprise a combination of unconventional heating techniques, electric heating techniques, fluid heating techniques, gas heating techniques, and any suitable techniques.

In embodiments of the invention, there is provided a material treatment process that embodies the two-direction heating system according to the invention. Such material treatment process includes for example heating, melting, extruding, reacting, material decomposition, and combinations thereof. Other treatment processes such as material catalytic treatment, material surface treatment, material extraction, material processing, and combinations thereof are also within the scope of the invention.

In embodiments of the invention, there is provided an extrusion device that embodies the two-direction heating system according to the invention. The extrusion device may be a plastic extrusion device, which can be used in the plastic processing industry. As will be understood by a skilled person, the extrusion device according to the invention may be used in the extrusion process of other materials different from plastic, as desired. Such materials include for example other types of polymers as well as non-polymers.

In embodiments of the invention, there is provided a material treatment plant or material processing plant that embodies the two-direction heating system according to the invention, and/or the material treatment process according to the invention, and/or the material extrusion device according to the invention. Such material treatment or processing includes for example plants for heating, melting, extruding, reacting, material decomposition, and combinations thereof. Other treatment processes such as material catalytic treatment, material surface treatment, material extraction, material processing, material mixing, material thermal processing, material compression, material blending, and combinations thereof may also be conducted at the plant according to the invention.

In embodiments of the invention, the material may be a polymer-containing material, an organic material, an inorganic material, a non-polymer material, a metal, a ceramic, concrete, modelling clay, foodstuffs, a hybrid material, or a mixture thereof.

The invention thus provides the following in accordance with aspects thereof.
(1). A two-direction heating system comprising one or more heat-absorber modules, each heat-absorber module comprising a heat-absorber barrel, a heat-absorber screw attached to an internal region of the barrel, and one or more heating units each attached to an external region of the barrel, wherein heat generated by the heating unit and delivered to first heat-absorber receptors provided on an inner surface of the barrel and second heat-absorber receptors provided on an outer surface of the screw, circulates from the barrel to the screw and from the screw to the barrel, and is thereby transferred to a material placed in the interior region of the heat-absorber barrel.
(2). The two-direction heating system according to (1) above, wherein the heating unit is adapted for at least one of: microwave heating, plasma, ultrasound, induction heating, electric heating, fluid heating, and gas heating.
(3). The two-direction heating system according to (1) or (2) above, wherein the heating unit comprises four heating units, or three units, or two units, or one unit.
(4). The two-direction heating system according to any one of (1) to (3) above, wherein each heat-absorber module comprises two or more heating units and each heating unit is independently adapted for at least one of: microwave heating, plasma, ultrasound, induction heating, electric heating, fluid heating, and gas heating.
(5). The two-direction heating system according to any one of (1) to (3) above, wherein each heat-absorber module comprises two or more heating units and each heating unit is independently adapted for at least one of microwave heating, plasma, ultrasound, and induction heating.
(6). The two-direction heating system according to any one of (1) to (5) above, wherein the heating units are adapted for microwave heating.
(7). The two-direction heating system according to any one of (1) to (6) above, wherein the heating unit comprises a heat generator.
(8). The two-direction heating system according to any one of (1) to (7) above, wherein each heat-absorber module comprises two or more heating units and each heating units is operable separately and selectively, as desired.
(9). The two-direction heating system according to any one of (1) to (9) above, wherein the first and second heat-absorber receptors are made of different materials or a same material.
(10). The two-direction heating system according to any one of (1) to (9) above, wherein the first and second heat-absorber materials are each independently made of a material which comprises silicon carbide.
(11). The two-direction heating system according to any one of (1) to (10) above, wherein the heating unit comprises one or more temperature-control elements which allow for a control of the temperature of the internal region of the heat-absorber barrel.
(12). The two-direction heating system according to any one of (1) to (11) above, wherein the heating unit comprises one or more heat outlets.
(13). The two-direction heating system according to any one of (1) to (12) above, further comprising an inlet or feeder for feeding the material into the barrel and an outlet for retrieving the heated material from the barrel.
(14). The two-direction heating system according to any one of (1) to (13) above, which is adapted for operation at ambient pressure, at a pressure higher than ambient pressure, or at a pressure lower than ambient pressure.
(15). The two-direction heating system according to any one of (1) to (14) above, further comprising an enclosure covering the heat-absorber modules.
(16). The two-direction heating system according to any one of (1) to (15) above, which is adapted for batch operation, semi-batch operation, continuous flow operation, or a combination thereof.
(17). The two-direction heating system according to any one of (1) to (16) above, which is adapted for operation in a small scale, a medium scale, or large scale.
(18). The two-direction heating system according to any one of (1) to (17) above, which is a mobile system.
(19). A process for treating a material comprising: (a) providing a system comprising one or more heat-absorber modules, each heat-absorber module comprising a heat-absorber barrel, a heat-absorber screw attached to an internal region of the barrel, and one or more heating units each attached to an external region of the barrel; (b) placing the material in the interior region of the barrel; (c) generating heat through the heating unit, the heat being delivered to first heat-absorber receptors provided on an inner surface of the barrel and second heat-absorber receptors provided on an outer surface of the screw, the heat circulating from the barrel to the screw and from the screw to the barrel, and the heat being thereby transferred to a material placed in the interior region of the barrel; and (d) retrieving the treated material from the barrel.
(20). The material treatment process according to (19) above, wherein treatment of the material comprises heating, melting, extruding, chemical reaction, material decomposition, material catalytic treatment, material surface treatment, material extraction, material processing, material mixing, material thermal processing, material compression, material blending, and combinations thereof.
(21). A material extrusion system comprising one or more heat-absorber modules, each heat-absorber module comprising: a heat-absorber barrel, a heat-absorber screw attached to an internal region of the heat-absorber barrel, and one or more heating units each attached to an external region of the heat-absorber barrel, wherein heat generated by the heating unit and delivered to first heat-absorber receptors provided on an inner surface of the barrel and second heat-absorber receptors provided on an outer surface of the screw, circulates from the barrel to the screw and from the screw to the barrel and is thereby transferred to a material placed in the interior region of the heat-absorber barrel.
(22). The material extrusion system according to (21) above, wherein the heat-absorber barrel further comprises an inlet for feeding the material in the barrel and an outlet for retrieving extruded material from the barrel.
(23). The material extrusion system according to (21) or (22) above, wherein the material is a polymer-containing material; preferably the material is plastic.
(24). The material extrusion system according to any one of (21) to (23) above, for use in a processing facility; preferably a plastic processing facility.
(25). The two-direction heating system as defined in any one of (1) to (18) above, or the material treatment process as defined in (19) or (20) above, or the material extrusion system as defined in any one of (21) to (24) above, wherein the material is selected from the group consisting of: polymer-containing material, organic material, inorganic material, non-polymer material, metals, ceramics, concrete, modelling clay, foodstuffs, hybrid material, and a mixture thereof.
(26). A material treatment plant or material processing plant, which embodies the two-direction heating system as defined in any one of (1) to (18) above, or the material treatment process as defined in (19) or (20) above, or the material extrusion system as defined in any one of (21) to (24) above.
(27). The two-direction heating system as defined in any one of (1) to (18) above, or the material treatment process as defined in (19) or (20) above, or the material extrusion system as defined in any one of (21) to (24) above, wherein the heat-absorber module is a microwave-absorber module, the heat-absorber barrel is a microwave-absorber barrel, the heat-absorber screw is a microwave-absorber screw, the first and second heat-absorber receptors are first and second microwave-absorber receptors, the heat generator is a microwave generator, and/or the heat outlet is a microwave outlet.
(28). A two-direction heating system comprising one or more microwave-absorber modules, each microwave-absorber module comprising: a microwave-absorber barrel, a microwave-absorber screw attached to an internal region of the barrel, and one or more heating units each attached an external region of the barrel, wherein heat generated by the heating unit and delivered to first microwave-absorber receptors provided on an inner surface of the barrel and second microwave-absorber receptors provided on an outer surface of the screw, circulates from the barrel to the screw and from the screw to the barrel, and is thereby transferred to a material placed in the interior region of the barrel.
(29). A process for treating a material, comprising: (a) providing a system comprising one or more microwave-absorber modules, each microwave-absorber module comprising a microwave-absorber barrel, a microwave-absorber screw attached to an internal region of the barrel, and one or more heating units each attached an external region of the barrel; (b) placing the material in the interior region of the barrel; (c) generating heat through the heating units, the heat being delivered to first microwave-absorber receptors provided on an inner surface of the barrel and second microwave-absorber receptors provided on an outer surface of the screw, the heat circulating from the barrel to the screw and from the screw to the barrel, and the heat being thereby transferred to the material placed in the interior region of the barrel; and (d) retrieving the treated or processed material from the barrel.
(30). A material extrusion system comprising one or more heat-absorber modules, each heat-absorber module comprising: a heat-absorber barrel, a heat-absorber screw attached to an internal region of the barrel, and one or more heating units each attached an external region of the heat-absorber barrel, wherein heat generated by the heating unit and delivered to first microwave-absorber receptors provided on an inner surface of the barrel and second microwave-absorber receptors provided on an outer surface of the screw, circulates from the barrel to the screw and from the screw to the barrel, and is thereby transferred to a material placed in the interior region of the barrel.
(31). The two-direction heating system as defined in (6) or (28) above, or the material treatment process as defined in (29) above, or the material extrusion system as defined in (30) above, wherein heat is further generated within the material upon interaction between the material and the microwave.

Other objects, advantages and features of the present invention will become more apparent upon reading of the following non-restrictive description of specific embodiments thereof, given by way of example only with reference to the accompanying drawings.

### BRIEF DESCRIPTION OF THE DRAWINGS

In the appended drawings:

FIGS. 1A and 1B: Microwave heating system according to the invention.

FIG. 2: Microwave-absorber barrel modules.

FIGS. 3A and 3B: Microwave heating unit.

FIG. 4: Microwave-absorber screw-exterior, and microwave absorber barrel-interior.

FIG. 5: Microwave heating system according to the invention, with large-power capacity heating units.

FIG. 6: Microwave-absorber screw covered with a microwave-absorber material.

### DESCRIPTION OF ILLUSTRATIVE EMBODIMENTS

Before the present invention is further described, it is to be understood that the invention is not limited to the particular embodiments described below, as variations of these embodiments may be made and still fall within the scope of the appended claims. It is also to be understood that the terminology employed is for the purpose of describing particular embodiments; and is not intended to be limiting. Instead, the scope of the present invention will be established by the appended claims.

In order to provide a clear and consistent understanding of the terms used in the present specification, a number of definitions are provided below. Moreover, unless defined otherwise, all technical and scientific terms as used herein have the same meaning as commonly understood to one of ordinary skill in the art to which this disclosure pertains.

Use of the word “a” or “an” when used in conjunction with the term “comprising” in the claims and/or the specification may mean “one”, but it is also consistent with the meaning of “one or more”, “at least one”, and “one or more than one”. Similarly, the word “another” may mean at least a second or more.

As used in this specification and claim(s), the words “comprising” (and any form of comprising, such as “comprise” and “comprises”), “having” (and any form of having, such as “have” and “has”), “including” (and any form of including, such as “include” and “includes”) or “containing” (and any form of containing, such as “contain” and “contains”), are inclusive or open-ended and do not exclude additional, unrecited elements or process steps.

As used herein, the term “heat-absorber” refers to a material that is suitable for absorbing heat and transferring it to another material. Such heat may be produced by various means. For example, such heat may be produced by microwave heating, plasma, ultrasound, induction heating, electric heating, fluid heating, gas heating, and combinations thereof. When the heat is produced by microwave, the term “microwave-absorber” is used. Accordingly, as used herein, the term “heat-absorber” also refers to “microwave-absorber”.

As used herein, the term “polymer-containing material” refers to a material wherein polymer is present in the form of repeating chains of molecules. The terms “polymer-containing material” and “polymeric material” are sometimes used interchangeably in the present disclosure. The term refers to a material comprising of long, repeating chains of molecules. The term also refers to a material comprising at least one long, repeating chain of molecules. Such material may be for example plastic material. The material may be an organic material or an inorganic material. The material may be a synthetic polymer or a natural polymer. The material may be a material that can be extruded, decomposed and/or melted. The material may be a virgin material, a recycled material, a waste material, or a combination thereof. The term “polymer-containing material” further refers to polymers composed of natural or synthetic monomers, for example high-density polyethylene (HDPE), polypropylene (PP), polyethylene (PE), low-density polyethylene (LDPE), and other plastics.

As used herein, term “microwaves” refers to electromagnetic waves with frequencies between about 0.3 GHZ and about 300 GH.

As used herein, the term “material treatment” refers to the treatment of a material. Such treatment may comprise for example heating, melting, extruding, chemical reaction, material decomposition, material catalytic treatment, material surface treatment, material extraction, material processing, and combinations thereof. The material may be a material that is a polymer-containing material, an organic material, an inorganic material, a non-polymer material, or a mixture thereof. Herein, the term “material processing” is also used and refers to the processing of a material. Such processes are generally similar to the above-mentioned treatments of a material. Accordingly, the terms “material treatment” and “material processing” are used interchangeably.

As used herein, the term “attached to”, unless otherwise explicitly specified or limited, should be construed broadly as also meaning “mounted on/to” and “connected to” and may be, for example, fixedly connected, detachably connected, or integrally connected; can be mechanically or electrically connected; they may be connected directly or indirectly through intervening media, or they may be interconnected between two elements. The specific meaning of the above terms in the present invention can be understood in specific cases by those skilled in the art.

The inventors have designed and developed TO BE COMPLETED BY LAVERY UPON FILING.

It will be noted that throughout the appended drawings, like features are identified by like reference numerals.

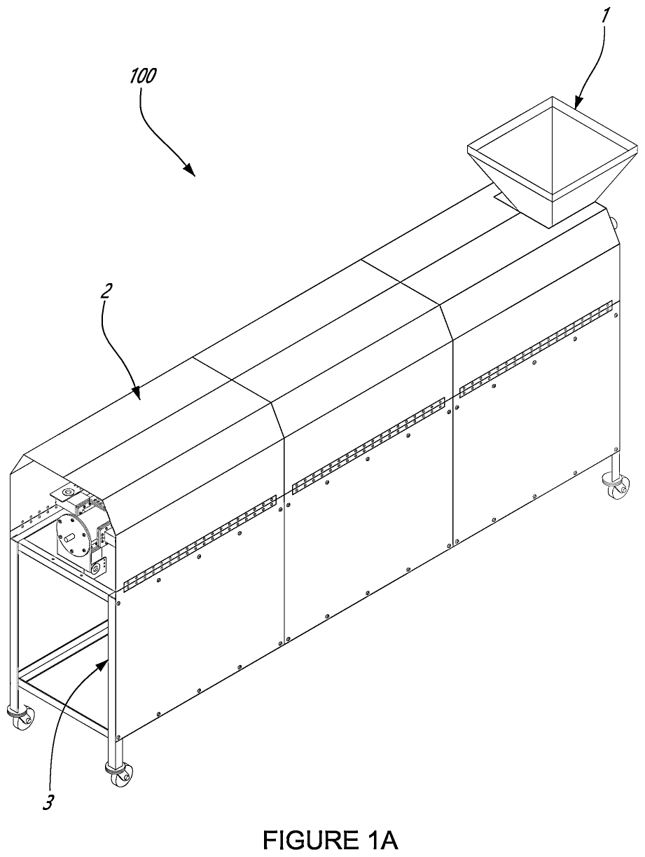

Referring to the figures, FIG. 1A illustrates the microwave heating system 100 according to the invention. The system generally comprises a plurality of modules, each module having a plurality of heating units attached thereto. More specifically, as illustrated in FIG. 1A and FIG. 1B, the system comprises a material feeder (1) for feeding the material to be heated into the barrel which is a microwave-absorber barrel (4). The system also comprises a barrel enclosure (2) and a frame (3). FIG. 1B also illustrates the screw which is a microwave-absorber screw (6) as well as a microwave heating unit (5).

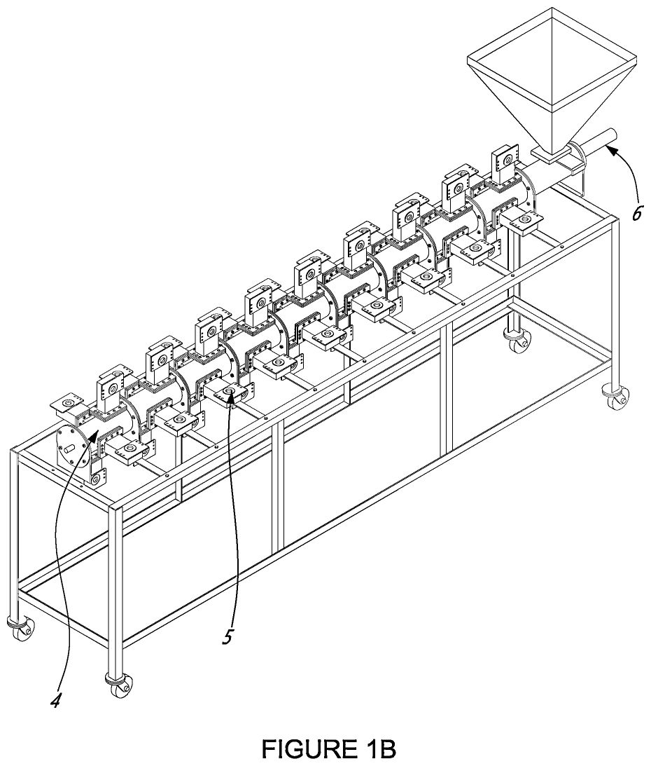

FIG. 2 illustrates the plurality of modules of the system according to the invention. Each module is a microwave-absorber barrel module (7) and has four heating units (5) attached thereto. FIG. 2 also illustrates a microwave-absorber barrel support (8), a wave enclosure (11), a wave inlet port (9), and a microwave-absorber module fastener (10).

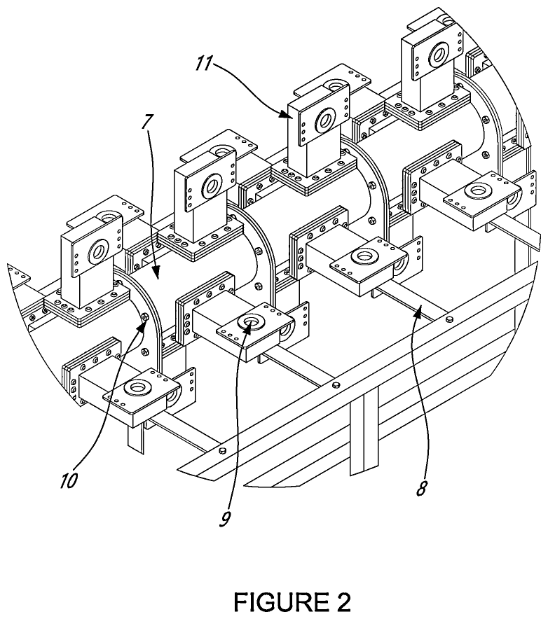

FIG. 3A and FIG. 3B illustrate a microwave-absorber barrel module (7) having four heating units (5) attached thereto. As can be seen, the system according to the invention also comprises a wave transmission strip (12), a microwave-absorber enclosure flange (13), a microwave-absorber module flange (14), a microwave enclosure fastener (15), a microwave generator (16), a microwave generator supporting frame (17), a microwave generator cooler (18), and a microwave generator electric connection (19).

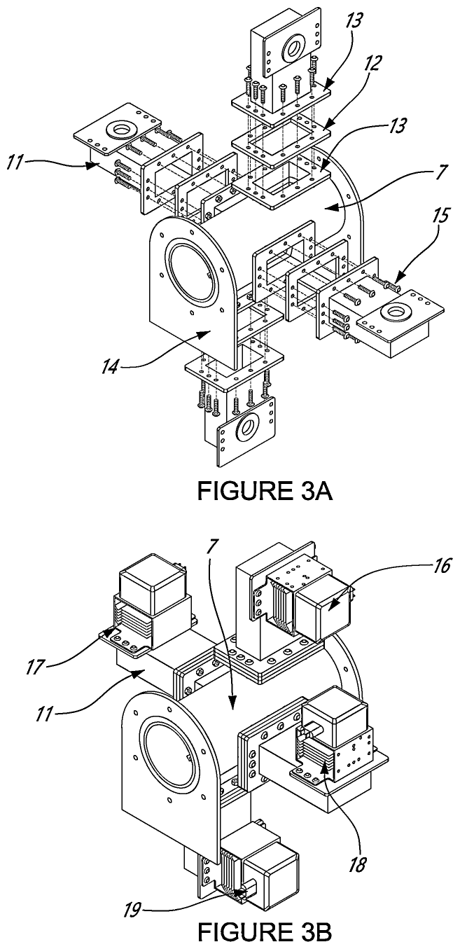

FIG. 4 illustrates the microwave-absorber screw (6) externally and the microwave-absorber barrel (4) internally. Microwave-absorber material (21) is provided and covers the outer surface of the microwave-absorber screw including its thread. The microwave-absorber material (21) also covers the inner surface of the microwave-absorber barrel (23). The system according to the invention also comprises a microwave inlet window (24).

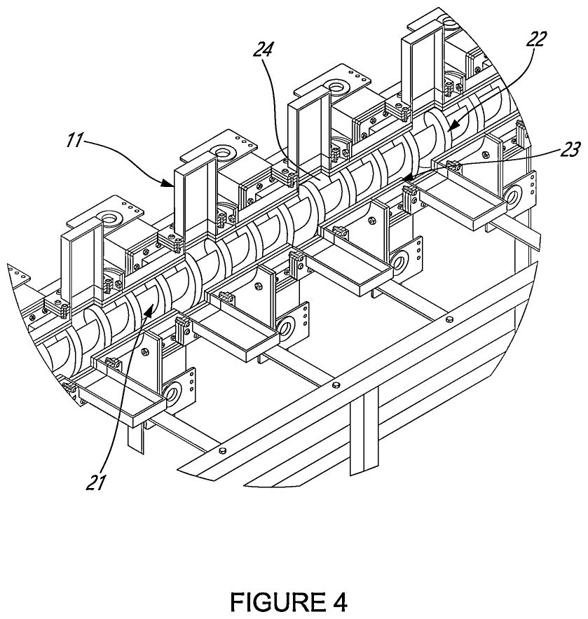

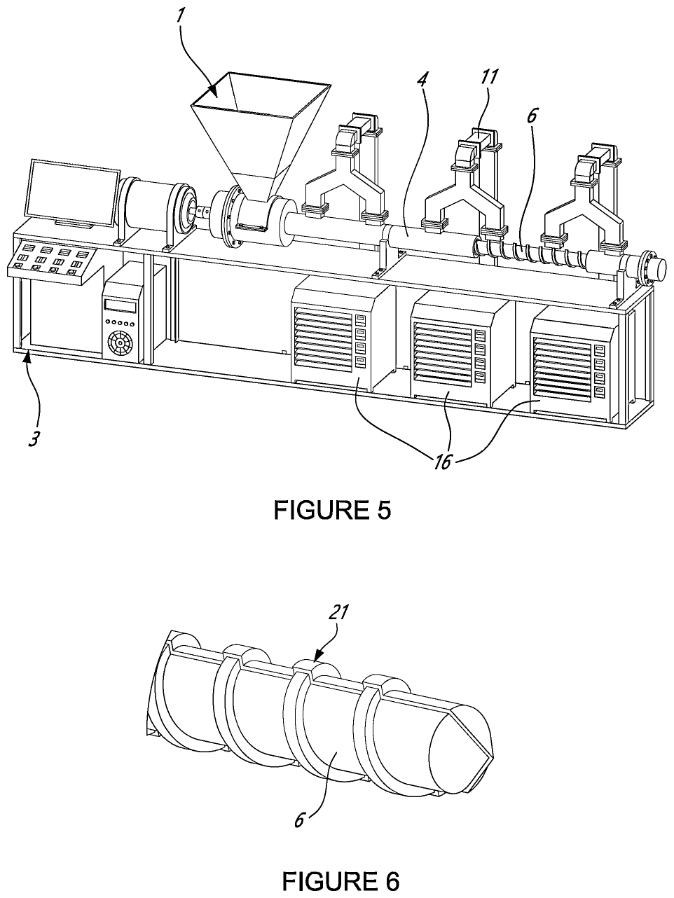

In FIG. 5 the microwave heating system 100 according to the invention is illustrated with the frame removed-a higher microwave power generator is used instead of a plurality of small microwave power generators. And in FIG. 6, the screw 6 is illustrated, which is covered with the microwave-absorber material (21).

In some embodiments, the material may be a polymer-containing material, for example, plastics. In some embodiments, the material may be organic and/or inorganic material. In some embodiments, the material may be a single material or a mixture of materials. In some embodiments, the material may be a microwave absorber, microwave transparent, microwave reflector, or a combination thereof.

In some embodiments, the microwave-absorber barrel may have an external side of its surface covered/coated with a microwave receptor. In some embodiments, the microwave-absorber barrel may have an internal side of its surface covered/coated with a microwave receptor. In some embodiments, the microwave-absorber barrel may be externally and internally covered/coated with a microwave receptor.

In some embodiments, the microwave-absorber barrel may be made of a microwave receptor. In some embodiments, the microwave-absorber barrel may be made of a microwave receptor mixed with another material or materials. In embodiments, the microwave receptor is a material that absorbs microwaves. In some embodiments, the microwave receptor may be one material or a mixture of several materials. In some embodiments, the microwave receptor may contain silicon carbide. In some embodiments, the microwave receptor is silicon carbide.

In some embodiments, the microwave receptor may be solid, liquid, gas, or a combination thereof.

In some embodiments, if the processed material is a strong/medium microwave receptor, the use a microwave receptor may be omitted.

In some embodiments, the microwave heating system further comprises a microwave generator or generators 16 (FIG. 3A and FIG. 3B) to provide the needed electromagnetic waves for the desired treatment which as will be understood by a skilled person, may be heating, melting, extrusion, chemical reaction, and/or decomposition of the material.

In some embodiments, the microwave generator generates the required microwave at desired power or powers. In some embodiments, the microwave generator generates the required microwave at the desired frequency or frequencies. In some embodiments, the microwave generator may be a magnetron-basis. In some embodiments, the microwave generator may be a solid-state-basis. In some embodiments, the microwave generator may be a magnetron or solid-state wave generator or a combination thereof. In some embodiments, the microwave generator may be a single generator or multi-generators. In some embodiments, the microwave generator may be a single unit containing microwave generators.

In some embodiments, the microwave generator may be distributed along the irradiation media (FIG. 3A and FIG. 3B). In some embodiments, the irradiation media is the microwave-absorber screw and/or the microwave-absorber barrel.

In some embodiments, the microwave generator may generate microwaves at a frequency from 300 MHz to 300 GHz. In some embodiments, the microwaves may be applied at a frequency range from about 915 MHz to about 2.45 GHZ, or higher, or lower. In some embodiments, the microwave generator may generate microwaves at a frequency of about 2.45 GHZ. In some embodiments, the microwaves are generated by the microwave generator at the desired frequency, for example, 2.45 GHZ.

In some embodiments, the wave enclosure 11 (FIG. 3A and FIG. 3B) is a wave manifold and/or a waveguide. In some embodiments, the wave enclosure may be used to transmit the generated waves from the microwave generator to the microwave-absorber barrel. In some embodiments, the wave enclosure may be used to transmit the generated waves from the microwave generator to the microwave-absorber screw. In some embodiments, the wave enclosure may be used to transmit the generated waves from the microwave generator to the microwave-absorber barrel and the microwave-absorber screw.

In some embodiments, the wave enclosure is connected on an external side of the surface of the microwave-absorber barrel. In some embodiments, the wave enclosure is connected on an internal side of the surface of the microwave-absorber barrel. In some embodiments, the wave enclosure may split the microwaves generated in the microwave generator into two streams or more.

In some embodiments, the wave enclosure is mounted on the top of the barrel. In some embodiments, the wave enclosure is mounted on the bottom of the barrel. In some embodiments, the wave enclosure is mounted on the left of the barrel. In some embodiments, the wave enclosure is mounted on the right of the barrel.

In some embodiments, the microwave manifold is mounted on the top and the bottom of the barrel. In some embodiments, the microwave manifold is mounted on the left and the right of the barrel. In some embodiments, the microwave manifold is mounted on the top, the bottom, the left, and/or the right of the barrel.

In some embodiments, the microwave manifold's steams on the top and the bottom of the barrel are aligned with each other. In some embodiments, the microwave manifold's steams on the top and the bottom of the barrel are not aligned with each other and, thus, better microwave distribution may be achieved. In some embodiments, the microwave manifold's steams on the left and the right of the barrel are aligned with each other. In some embodiments, the microwave manifold's steams on the left and the right of the barrel are not aligned with each other and, thus, better microwave distribution may be achieved.

In some embodiments, the microwave-absorber screw 6 may be a single screw, a twin screw, or a combination thereof. In some embodiments, the twin screw may be a co-rotating or a counter-rotating, or a combination thereof. In some embodiments, the microwave-absorber screw may be a single screw, a multiple screw, or a combination thereof. In some embodiments, the microwave-absorber screw may include a feeding zone, a compressions zone, and/or a metering zone. In some embodiments, the microwave-absorber screw may be a metering screw, a pin mixing screw, a Maddock mixing screw, a two-stage meter screw, a barrier screw, a barrier/mixing screw, or a combination thereof.

In some embodiments, the microwave-absorber screw may be externally covered/coated with a microwave receptor. In some embodiments, the microwave-absorber screw may be internally covered/coated with a microwave receptor. In some embodiments, the microwave-absorber screw may be externally and internally covered/coated with a microwave receptor. In some embodiments, the microwave-absorber screw may be made of a microwave receptor. In some embodiments, the microwave-absorber screw may be made of a microwave receptor mixed with at least one other material.

In some embodiments, the microwave-absorber barrel may be packed in a barrel enclosure 2 (FIG. 1). In such a case a reasonable clearance between the inner surface of the barrel enclosure and the outer surface of the barrel should be considered.

In some embodiments, the barrel enclosure may have a circular, a rectangular, or a square cross-section area. In some embodiments, the barrel enclosure may be another geometry or geometries.

In some embodiments, the electromagnetic waves enter the microwave-absorber barrel and interacted with the microwave receptor through an opening on the surface of the barrel.

In some embodiments, a microwave transmission strip 12 (FIG. 3A and FIG. 3B) is connected between the wave enclosure and the microwave-absorber barrel and covers the opening on the surface of the barrel. In some embodiments, the microwave transmission strip may be microwave-transparent, allowing microwaves to pass through without being absorbed. In some embodiments, the strip may withstand the operating pressure and temperature conditions. In some embodiments, the microwave transmission strip may not reflect or absorb microwaves. In some embodiments, the strip may be a non-conductive material. In some embodiments, the strip may be a non-magnetic material. In some embodiments, the strip may be made of mica, ceramics, quartz, glass, other material, or a combination thereof.

In some embodiments, an appropriate gasket for the operating pressure, temperature, and presence of microwave may be used to gasket the strip.

In some embodiments, a material feeder may be used to feed the material into the microwave-absorber barrel. In some embodiments, the material feeder may be made of a material or materials that reflects microwaves. In some embodiments, the material in which the feeder is made may be a material or mixture of materials that interacts with microwaves. In some embodiments, the material in which the feeder is made may increase the temperature of the material to be treated before it reaches the microwave-absorber screw.

In some embodiments, the microwave heating system may be batch operated, semi-batch operated, continuous flow operated, or a combination thereof. In some embodiments, the microwave heating device is a small scale, medium scale, or large scale. In some embodiments, the microwave heating device is a mobile system.

In some embodiments, the microwave heating system is not limited to polymeric materials as a processed material.

In some embodiments, the microwave heating system is not limited to the application of heating, melting, extruding, or decomposing a material. In some embodiments, the microwave heating device can be used in other applications, for example chemical reactions.

In some embodiments, the microwave heating system is not limited to microwave, it is applicable with the implementation of induction heating, ultrasound, electric field, magnetic field, plasma, or combinations thereof.

In some embodiments, the microwave heating system is not limited to microwave, it is applicable with the implementation of electromagnetic waves at any frequency or frequencies other than microwave.

In some embodiments, the heating, melting, extruding, reacting, or decomposing a material may be performed at ambient pressure condition. In some embodiments, the heating, melting, extruding, reacting, or decomposing a material may be performed at pressure condition higher than ambient pressure. In some embodiments, the heating, melting, extruding, reacting, or decomposing a material may be performed at pressure condition lower than ambient pressure.

In some embodiments, the microwaves are guided to the microwave-absorber barrel using the wave enclosure. In some embodiments, the microwaves enter the microwave enclosure through the microwave transmission strip.

In some embodiments, the electromagnetic waves interact with the microwave receptor which coats/covers the internal and/or external surface of the microwave-absorber barrel enclosure. In some embodiments, the electromagnetic waves interact with the microwave receptor which coats/covers the external surface the microwave-absorber screw. In some embodiments, the electromagnetic waves are directed inside the microwave-absorber screw to interact with the microwave receptor which coats/covers the internal surface of the microwave-absorber screw.

In some embodiments, the interaction between the electromagnetic waves and microwave receptor which coats/covers the internal surface of the microwave-absorber barrel leads to increase the temperature of the internal surface of the microwave-absorber barrel, thus, heat is mainly transferred to the screw direction.

In some embodiments, the interaction between the electromagnetic waves and microwave receptor which coats/covers the external surface of the microwave-absorber barrel leads to an increase in the temperature of the surface of the microwave-absorber barrel, thus, heat is mainly transferred to the screw direction.

In some embodiments, the interaction between the electromagnetic waves and microwave receptor which coats/covers the internal surface of the microwave-absorber screw leads to an increase in the temperature of the internal surface of the microwave-absorber screw, thus, heat is mainly transferred to the barrel direction.

In some embodiments, the interaction between the electromagnetic waves and microwave receptor which coats/covers the external surface of the microwave-absorber screw leads to increase in the temperature of the external surface of the microwave-absorber screw, thus, heat is mainly transferred to the barrel direction.

In some embodiments, the heat generated within the microwave receptor of the microwave-absorber screw and the microwave-absorber barrel leads to heat the material being fed by the feeder to the desired temperature.

In some embodiments, the heat generated within the microwave receptor of the microwave-absorber screw and the microwave-absorber barrel leads to heat the material being fed by the feeder to the desired temperature in two directions—from the screw to the barrel and from the barrel to the screw.

In some embodiments, the heat generated within the microwave receptor of the microwave-absorber screw and the microwave-absorber barrel leads to heat the material being fed by the feeder to the desired temperature, for example, from about 25° C. to about 1500° C.

In some embodiments, the desired temperature may be from about 25° C. to about 50° C., from about 50° C. to about 100° C., from about 100° C. to about 150° C., from about 150° C. to about 200° C., or from 200° C. to about 250° C.

In some embodiments, the desired temperature may be from about 250° C. to about 300° C., from about 300° C. to about 600° C., from about 600° C. to about 900° C., from about 900° C. to about 1200° C., or from about 1200° C. to about 1500° C.

In some embodiments, the desired temperature may be higher than 1500° C.

In some embodiments, the desired temperature depends on the applications of the heating process as well as the properties of material begins heated.

In embodiments of the invention wherein microwave is used, heat can also be generated within the material upon its interaction with the microwave. For example, if the dielectric loss factor of the heated material is higher than “0”, there will be interaction with the microwave. Thus, heat energy will also be generated within the material.

As will be understood by a skilled person, other variations and combinations may be made to the various embodiments of the invention as described herein above.

The present description refers to a number of documents, the content of which is herein incorporated by reference in their entirety.

The scope of the claims should not be limited by the preferred embodiments set forth herein above; but should be given the broadest interpretation consistent with the description as a whole.

1. A two-direction heating system comprising one or more heat-absorber modules, each heat-absorber module comprising: a heat-absorber barrel, a heat-absorber screw attached to an internal region of the barrel, and one or more heating units each attached to an external region of the barrel,
wherein heat generated by the heating unit and delivered to first heat-absorber receptors provided on an inner surface of the barrel and second heat-absorber receptors provided on an outer surface of the screw, circulates from the barrel to the screw and from the screw to the barrel, and is thereby transferred to a material placed in the interior region of the heat-absorber barrel.

2. The two-direction heating system according to claim 1, wherein:
the heating unit is adapted for at least one of: microwave heating, plasma, ultrasound, induction heating, electric heating, fluid heating, and gas heating; and/or
the heating unit comprises four heating units, or three units, or two units, or one unit.

3. (canceled)

4. The two-direction heating system according to claim 1, wherein each heat-absorber module comprises two or more heating units and each heating unit is independently adapted for at least one of: microwave heating, plasma, ultrasound, induction heating, electric heating, fluid heating, and gas heating;
preferably each heating unit is independently adapted for at least one of microwave heating, plasma, ultrasound, and induction heating.

5. (canceled)

6. The two-direction heating system according to claim 1, wherein the heating units are adapted for microwave heating; and/or
wherein the heating unit comprises a heat generator.

7. (canceled)

8. The two-direction heating system according to claim 1, wherein each heat-absorber module comprises two or more heating units and each heating units is operable separately and selectively, as desired.

9. The two-direction heating system according to claim 1, wherein:
the first and second heat-absorber receptors are made of different materials or a same material; and/or
the first and second heat-absorber materials are each independently made of a material which comprises silicon carbide.

10. (canceled)

11. The two-direction heating system according to claim 1, wherein:
the heating unit comprises one or more temperature-control elements which allow for a control of the temperature of the internal region of the heat-absorber barrel; and/or
the heating unit comprises one or more heat outlets.

12. (canceled)

13. The two-direction heating system according to claim 1, further comprising an inlet or feeder for feeding the material into the barrel and an outlet for retrieving the heated material from the barrel.

14. The two-direction heating system according to claim 1, which is adapted for operation at ambient pressure, at a pressure higher than ambient pressure, or at a pressure lower than ambient pressure.

15. The two-direction heating system according to claim 1, further comprising an enclosure covering the heat-absorber modules.

16. The two-direction heating system according to claim 1, which is adapted for batch operation, semi-batch operation, continuous flow operation, or a combination thereof; and/or
which is adapted for operation in a small scale, a medium scale, or large scale; and/or
which is a mobile system.

17. (canceled)

18. (canceled)

19. A process for treating a material comprising:
(a) providing a system comprising one or more heat-absorber modules, each heat-absorber module comprising: a heat-absorber barrel, a heat-absorber screw attached to an internal region of the barrel, and one or more heating units each attached to an external region of the barrel;
(b) placing the material in the interior region of the barrel;
(c) generating heat through the heating unit, the heat being delivered to first heat-absorber receptors provided on an inner surface of the barrel and second heat-absorber receptors provided on an outer surface of the screw, the heat circulating from the barrel to the screw and from the screw to the barrel, and the heat being thereby transferred to a material placed in the interior region of the barrel; and
(d) retrieving the treated material from the barrel.

20. The material treatment process according to claim 19, wherein treatment of the material comprises heating, melting, extruding, chemical reaction, material decomposition, material catalytic treatment, material surface treatment, material extraction, material processing, material mixing, material thermal processing, material compression, material blending, and combinations thereof.

21. A material extrusion system comprising one or more heat-absorber modules, each heat-absorber module comprising: a heat-absorber barrel, a heat-absorber screw attached to an internal region of the heat-absorber barrel, and one or more heating units each attached to an external region of the heat-absorber barrel,
wherein heat generated by the heating unit and delivered to first heat-absorber receptors provided on an inner surface of the barrel and second heat-absorber receptors provided on an outer surface of the screw, circulates from the barrel to the screw and from the screw to the barrel and is thereby transferred to a material placed in the interior region of the heat-absorber barrel.

22. The material extrusion system according to claim 21, wherein the heat-absorber barrel further comprises an inlet for feeding the material in the barrel and an outlet for retrieving extruded material from the barrel.

23. The material extrusion system according to claim 21, wherein the material is a polymer-containing material; preferably the material is plastic.

24. The material extrusion system according to claim 21, for use in a processing facility; preferably a plastic processing facility.

25. The two-direction heating system as defined in claim 1, wherein:
the material is selected from the group consisting of: polymer-containing material, organic material, inorganic material, non-polymer material, metals, ceramics, concrete, modelling clay, foodstuffs, hybrid material, and a mixture thereof; and/or
the heat-absorber module is a microwave-absorber module, the heat-absorber barrel is a microwave-absorber barrel, the heat-absorber screw is a microwave-absorber screw, the first and second heat-absorber receptors are first and second microwave-absorber receptors, the heat generator is a microwave generator, and/or the heat outlet is a microwave outlet.

26. A material treatment plant or material processing plant, which embodies the two-direction heating system as defined in claim 1.

27-30. (canceled)

31. The two-direction heating system as defined in claim 6, wherein heat is further generated within the material upon interaction between the material and the microwave.
